(19) United States
(12) Patent Application Publication
(10) Pub. No.: US 2007/0063537 A1
(43) Pub. Date: Mar. 22, 2007

(54) Operating device and method of operating body components of a vehicle

(75) Inventors: Johannes Preis, Bad Abbach/Lengfeld (DE); Bernd Hollerbaum, Lauf (DE)

Correspondence Address: BROWDY AND NEIMARK, P.L.L.C.;624 NINTH STREET, NW, SUITE 300, WASHINGTON, DC, 20001-5303, US

(73) Assignee: Suspa Holding GmbH, Altdorf (DE)

(21) Appl. No.: 11/515,769

(22) Filed: Sep. 6, 2006

(30) Foreign Application Priority Data
Sep. 6, 2005 (DE) 10 2005 042 408.2

(51) Int. Cl. B60J 5/00

(52) U.S. Cl. 296/146.4

(57) ABSTRACT

In an operating device for operating body components of a vehicle, it is provided, with a view to obtaining simple automatic operation as well as unrestricted manual operation, that an electromechanical drive unit comprises at least one drivable first stop element and a power transmission unit at least one second stop element which is connected to the body component, the stop elements being able to bear against each other for transmission of an operation power in a direction of power transmission and to be spaced from each other for uncoupling the drive unit from the power transmission unit in the direction of power transmission. There is no need for any electromechanical coupling for uncoupling purposes.

### BACKGROUND OF THE INVENTION

### Field of the Invention

The invention relates to an operating device for operating body components, in particular a tailgate, of a vehicle. The invention further relates to a method for operating body components, in particular a tailgate, of a vehicle.

Operating devices for operation of a tailgate comprise a drive unit and a power transmission unit, an electromechanical coupling being provided for uncoupling them. The electromechanical coupling is disposed between the drive unit and the power transmission unit and enables uncoupling in such a way that unrestricted manual operation of the tailgate is possible when the coupling is released if desired. Drawbacks reside in that operating devices of that type are complicated and expensive due to the electromechanical coupling.

### SUMMARY OF THE INVENTION

It is an object of the invention to embody a simple operating device and a simple method for operating body components of a vehicle so that simple automatic operation as well as unrestricted manual operation of body components is possible.

According to the invention, this object is attained by an operating device for operating body components of a vehicle, comprising

an electromechanical drive unit for producing an operating power, having a drive motor which is able to be triggered electronically, and at least one first stop element which is drivable by the drive motor;

a power transmission unit for transmitting the operating power to at least one body component, the power transmission unit having at least one operating element which is connected to the at least one body component, and at least one second stop element which is connected to the at least one operating element and cooperates with the at least one first stop element;

the drive unit and the power transmission unit being configured such that the at least one first stop element being disposable to bear against the at least one second stop element for transmission of the operating power to the at least one second stop element in a direction of power transmission, and the at least one first stop element being able to be spaced from the at least one second stop element for uncoupling of the drive unit from the power transmission unit in the direction of power transmission.

According to the invention, this object is also attained by a method for operating body components of a vehicle, comprising the steps of

provision of an operating device, having an electromechanical drive unit (9) for producing an operating power, the drive unit having at least one drivable first stop element, and a power transmission unit for transmitting the operating power to at least one body component, the power transmission unit having at least one second stop element which is connected to the at least one body component; and

triggering of the drive unit such that the at least one first stop element for transmission of the operating power to the at least one second stop element in a direction of power transmission is disposed to rest on the at least one second stop element, and such that the at least one first stop element for uncoupling the drive unit from the power transmission unit is disposed at a distance from the at least one second stop element in the direction of power transmission.

The gist of the invention resides in that the electromechanical drive unit comprises at least one drivable first stop element and the power transmission unit comprises at least one second stop element which is connected to the at least one body component to be operated, the at least one first stop element being disposable to bear against the at least one second stop element for transmission of the operating power from the drive unit to the power transmission unit in the direction of power transmission and to be spaced from the at least one second stop element for uncoupling of the drive unit from the power transmission unit in the direction of power transmission. If the at least one first stop element bears against the at least one second stop element, power transmission from the drive unit to the power transmission unit in the direction of power transmission is possible, the at least one body component thereby being automatically operable. If the at least one stop element is spaced from the at least one second stop element in the direction of power transmission, then power transmission from the drive unit to the power transmission unit is not possible, whereby they are uncoupled and unrestricted manual operation of the at least one body component is possible. As a result of the configuration, according to the invention, of the drive unit and the power transmission unit, an engageable and disengageable electromechanical coupling mechanism is no longer necessary for uncoupling the drive unit and the power transmission unit, the result being structural simplicity and high reliability of the operating device.

Further advantages and features of the invention will become apparent from the ensuing description of a preferred exemplary embodiment, taken in conjunction with the drawing.

### BRIEF DESCRIPTION OF THE DRAWING

FIG. 1 shows a diagrammatic plan view of the operating device for operation of a tailgate of a vehicle, with the tailgate shut;

FIG. 2 shows a diagrammatic illustration of the operating device according to FIG. 1 with the tailgate opened;

FIG. 3 shows a sectional illustration of the operating device in a position of rest with the tailgate shut according to FIG. 1;

FIG. 4 shows a sectional illustration of the operating device in a position of opening with the tailgate opened according to FIG. 2;

FIG. 5 shows a sectional illustration of the operating device in a position of closing with the tailgate closed according to FIG. 1; and

FIG. 6 shows a sectional illustration of the operating device according to FIG. 5 on the line VI-VI.

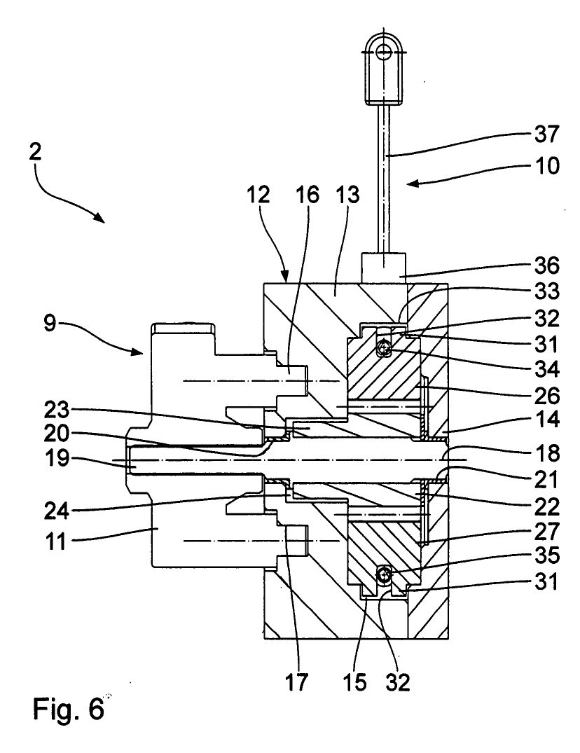

### BRIEF DESCRIPTION OF THE PREFERRED EMBODIMENT

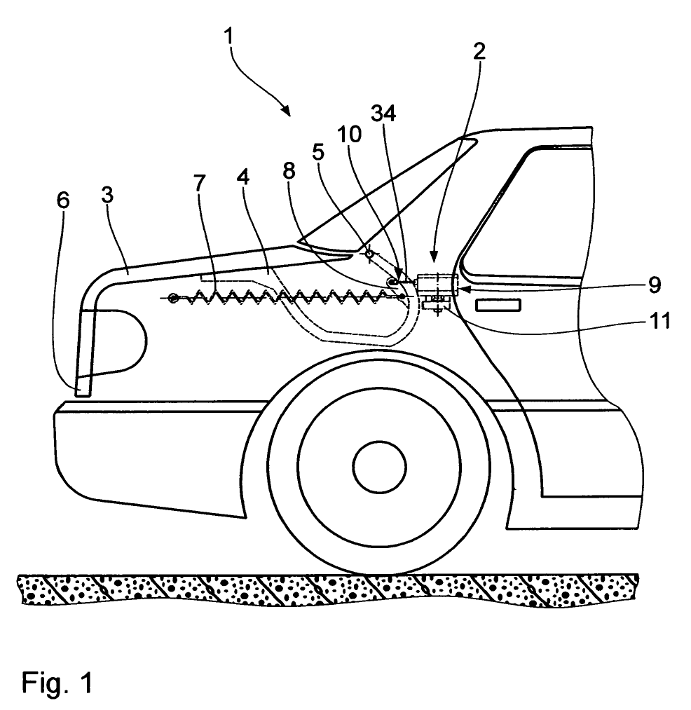

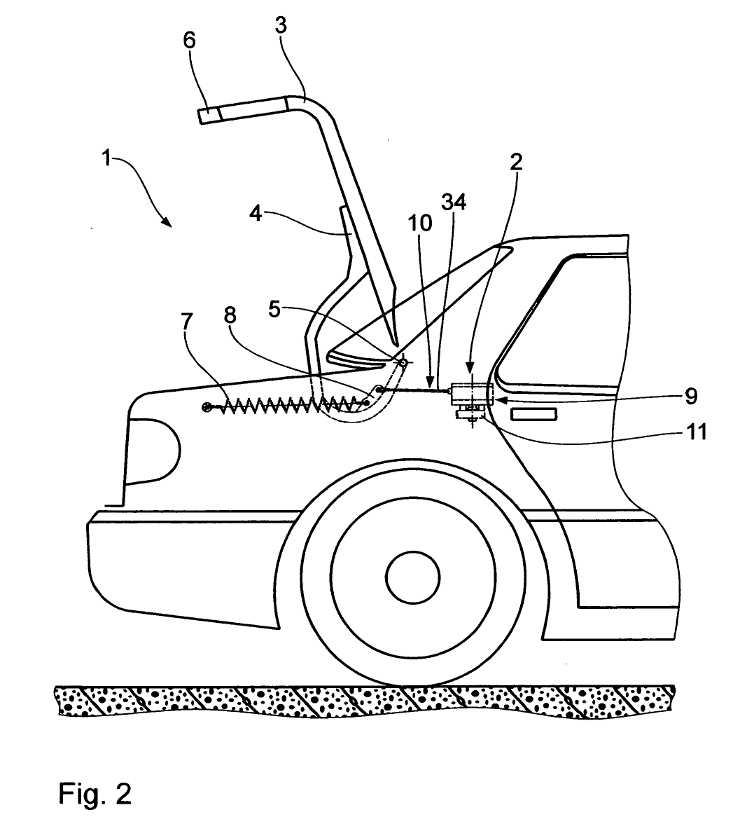

FIGS. 1 and 2 diagrammatically illustrate an operating device 2, installed in a vehicle 1, for operation of a body component 3 in the form of a tailgate. In the following, the body component 3 is called tailgate. The tailgate 3 is connected to pivoted bows 4 which are disposed on the vehicle 1, pivoted about a pivoting axis 5 for the tailgate 3 to be opened and closed. For the tailgate 3 to be locked when it is shut, provision is made for a locking unit 6 in the form of a tailgate lock, which is only roughly outlined in FIGS. 1 and 2. The locking unit 6 is of familiar design and disposed on the tailgate 3 of the vehicle 1.

For the tailgate 3 to open automatically, energy storage elements 7 are provided in the form of helical springs. By a first end, the energy storage elements 7 are fixed to the vehicle 1 and by a second element to a fastening lug 8 of the respective pivoted bow 4. The energy storage elements 7 are designed in such a way that the momentum of turning about the pivoting axis 5 which is produced by the weight of the tailgate 3 is overcompensated by the energy storage elements 7 so that the tailgate 3 automatically pivots from a closed position according to FIG. 1 into an opened position according to FIG. 2 as soon as the locking unit 6 is unlocked. Such a design of the energy storage elements 7 is indispensable for use of the operating device 2 described below. Depending on the use and design, the energy storage elements 7 may have any configuration, for example in the form of extension springs, compression springs, gas compression springs, torsion springs or additional weights.

The operating device 2 is comprised of an electromechanic drive unit 9 for producing an operating power and a power transmission unit 10 for transmitting the operating power to the tailgate 3. The drive unit 9 comprises a drive motor 11 which can be triggered electronically and which is disposed externally and substantially centrically on a cuboid casing 12. The casing is of two-piece design, having a basic structure 13 and a cover 13 fixable thereto, the basic structure 13 and the cover 14 confining an interior 15.

The drive motor 11 is disposed on the side of the basic structure 13 that is turned away from the cover 14, having stepped fastening pins 16 which are molded on integrally as a safeguard against rotation in relation to the casing 12 and which engage with correspondingly shaped recesses 17 of the casing 12. Fixing the drive motor 11 to the casing 12 is effected by the aid of known fastening means.

A drive shaft 19 of the drive motor 11, which is drivable in rotation about an axis of rotation 18 is led into the casing interior 15 through a casing bore 20 in the form of a first bearing which passes through the basic structure 13. The drive shaft 19 extends through the interior 15 as far as to the cover 14 and is located in a bore 21 of the cover 14 in the form of a second bearing for rotation about the axis of rotation 18. A gearwheel 22 is mounted on the drive shaft 19 in the casing interior 15 between the basic structure 13 and the cover 14; it is connected to the drive shaft 19 and rotatably drivable about the axis of rotation 18 by means of the drive motor 11. For being lodged in the basic structure 13 of the casing 12, the gearwheel 22 has a bearing prolongation 23 which is molded on integrally and accommodated in a bearing recess 24 of corresponding shape which is disposed concentrically of the axis of rotation. By alternative, provision can be made for several gearwheels 22 or, additionally, a gearing that is integrated in the drive motor 11.

The casing interior 15 is substantially H-shaped, two casing ribs 25, which are molded integrally on the basic structure 13, proceeding therefrom into the interior 15 as far as to the gearwheel 22. The basic structure 13, the cover 14 and the ribs 25 constitute guides for a first rack 26 and a second rack 27 which are disposed in the casing interior 15. The racks 26, 27 mesh with the gearwheel 22 and, upon rotation of the gearwheel in a direction of rotation 28, the first rack 26 is movable into a first direction of power transmission 29 and the second rack into a second direction of power transmission 30.

On a side that faces away from the gearwheel 22, the first rack 26 comprises a first stop element 31 which projects transversely to the first direction of power transmission 29 and is formed integrally on a first end of the rack 26 as seen in the first direction of power transmission 29. The first stop element 31 comprises a groove 32 which runs in the first direction of power transmission 29 and completely passes through the first first stop element 31. The projecting first stop element 31 extends into a locating groove 33 which is formed by the basic structure 13 and the cover 14 of the casing 12. In the first direction of power transmission 29, the locating groove 33 forms a clearance for the motion of the first stop element 31. The second rack 27 is provided with a first stop element 31 of corresponding shape and arrangement.

The drive unit 9 comprises the drive motor 11, the casing 12, the gearwheel 22 and the first and second rack 26, 27 with the respective first stop element 31.

The power transmission unit 10 comprises a first operating element 34 that is allocated to the first rack 26and a second operating element 35 that is allocated to the second rack 27. The operating elements 34, 35, by an end turned away from the casing 12, are fixed to the fastening lug 8 of the associated pivoted bow 4 of the tailgate 3. The operating elements 34, 35 are Bowden cables, enabling tensile forces to be transmitted which act on the operating elements 34, 35 in the respective direction of power transmission 29, 30. The operating elements 34, 35 in the form of Bowden cables are of familiar design, having a flexible coating 36 and a wire cable 37 guided therein.

The first operating element 34 is led into the interior 15 through a passage 38 that cuts through the basic structure 13 of the casing 12. The passage 38 extends in the first direction of power transmission 29 and is disposed on the side, turned towards the first stop element 31, of the basic structure 13 for it to be in alignment with the groove 32 of the stop element 31. On its end, guided in the casing interior 15, the first operating element 34 has a second stop element 39. The second stop element 39 is connected to the first operating element 34 and disposed downstream of the first stop element 31 in the first direction of power transmission 29 in such a way that the first operating element 34 is led substantially in a straight line through the casing interior 15 and the stop-element groove 32. The second stop element 39 has greater diameter than the stop-element groove 32 so that the first stop element 31 and the second stop element 39 form a rear recess. The first stop element 31 cooperates with the second stop element 39 for transmission of an operating force from the drive unit 9 to the power transmission unit 10. The power transmission from the first stop element 31 to the second stop element 39 is implemented by the stop elements 31, 39 resting on each other. The second operating element 35 is correspondingly led into the casing interior 15 and provided with a second stop element 39.

Flexible damping elements 40 are respectively disposed between the stop elements 31, 39. The damping elements 40 serve for absorption of the impact of the stop elements 31, 39 on one another. The support of the stop elements 31, 39 on one another, which is required for power transmission—as described above—consequently comprises the indirect rest on one another of the stop elements 31, 39, while they directly bear against the respective damping element 40.

The second stop elements 39, on a side turned away from the damping elements 40, are connected to a spring element 41 in the form of a helical spring. The spring elements 41 substantially extend in the respective direction of power transmission 29, 30 and, as related to the first stop elements 31, are fixed to the basic structure 13 opposite the respective passage 38. Alternatively, the operating elements 34, 35 may also be coiled up.

The power transmission unit 10 comprises the operating elements 34, 35, the second stop elements 39, the damping elements 40 and the spring elements 41.

The operating device 2 is disposed in the vehicle 1 in an area below the rear package tray, where it is fixed. A control unit (not shown) is provided for triggering the drive unit 9. The control unit is disposed in the vicinity of the drive motor and is in signalling connecting with the sensors and with a central control unit for the vehicle 1. Alternatively, the drive unit 9 can also be triggered by the central control unit.

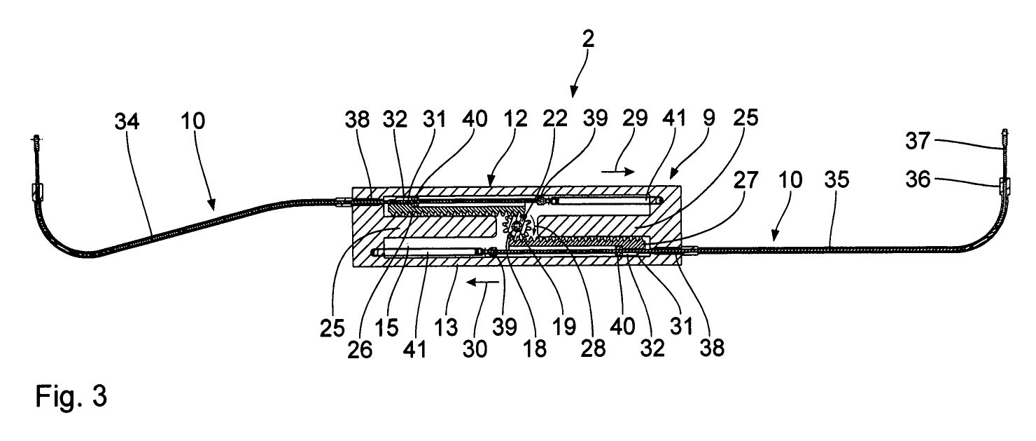

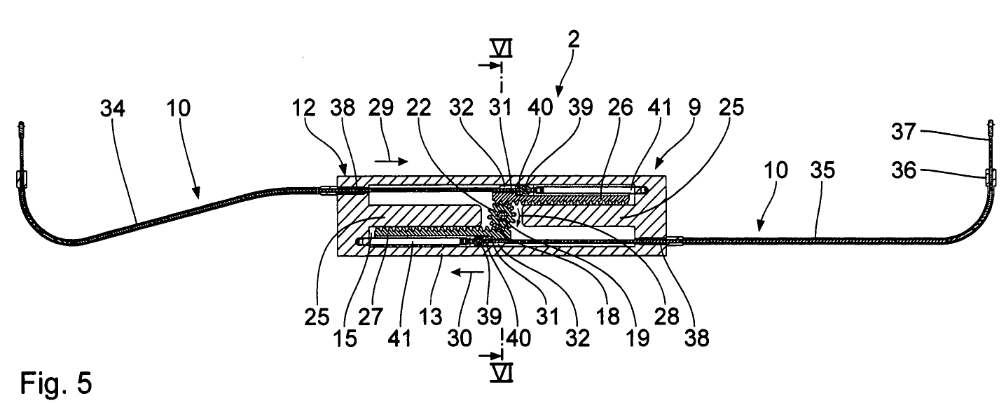

Depending on the desired scope of functions of the operating device 2, various sensor are provided, which are in signalling connecting with the control unit. In its simplest configuration, the operating device 2 comprises limit switches as sensors for detecting the position of rest according to FIG. 3 and the position of closing according to FIG. 5. For detection of the position of the tailgate 3, a position sensor my further be integrated in the operating device 2. Furthermore, for detection of the speed of the drive motor 11, provision can be made for a speed sensor, for example a Hall probe.

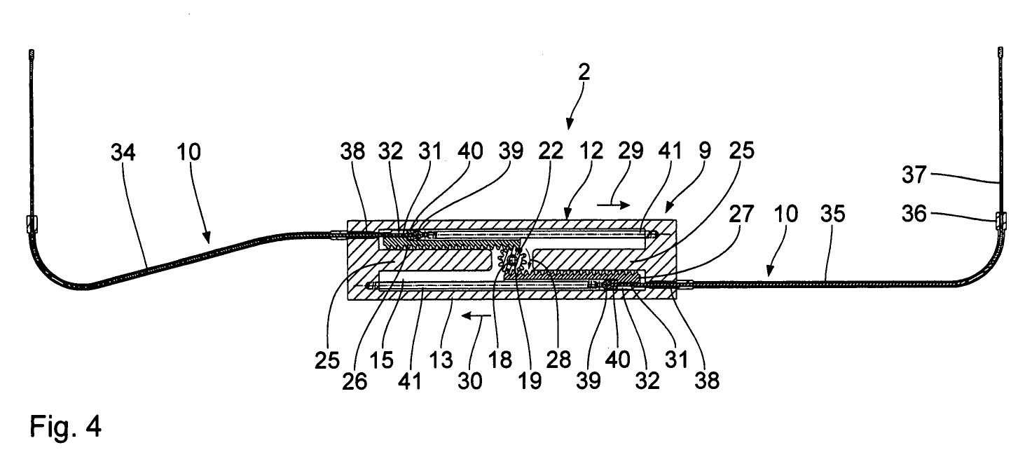

The mode of operation of the operating device 2 upon manual and automatic operation of the tailgate 3 will be described below. Opening the tailgate 3 will be explained first, based on FIGS. 1 and 3. The tailgate 3 is shut and locked by the locking unit 6. The energy storage elements 7 are preloaded in the shut position of the tailgate 3. The operating device 2 is in the position of rest seen in FIG. 3, with the cooperating first and second stop elements 31, 39 being spaced apart maximally in the respective direction of power transmission 29, 30. The operating elements 34, 35 are maximally retracted into the casing interior 15 by the tractive force of the spring elements 41. The racks 26, 27 are disposed in the casing interior 15 in such a way that the first stop elements 31 directly adjoin the respective passage 38. For the tailgate 3 to be opened, the locking unit 6 is unlocked, which can be implemented purely manually or by remote control. Being unlocked, the tailgate 3 automatically opens due to the pre-loaded energy storage elements 7 and pivots into the position seen in FIG. 2. The operating elements 34, 35, which are fixed to the fastening lugs 8 of the pivoted bows 4, are entrained and extracted from the casing interior 15 by the tailgate being pivoted. When the tailgate 3 reaches the position seen in FIG. 2, the second stop elements 39 hit against the respective damping element 40, the spring elements 41 being pre-loaded by the extraction of the operating elements 34, 35. This position of opening of the operating device 2 is illustrated in FIG. 4. Due to the fact that the stop elements 31, 39 do not bear against each other when the tailgate 3 is opened, the drive unit 9 is uncoupled from the power transmission unit 10 upon opening. Consequently, opening the tailgate 3 is not affected by the operating device 2.

Shutting the tailgate 3 manually will be described below in conjunction with FIGS. 2 and 4. The tailgate 3 is in the opened position illustration in FIG. 2. The operating device 2 has the position of opening seen in FIG. 4. When shut, the tailgate 3 is manually pivoted into the position seen in FIG. 1. During the pivoting process, the operating elements 34, 35, which are fixed to the fastening lugs 8 of the pivoted bows 4, are relieved and retracted into the casing interior 15 by the pre-loaded spring elements 41 until they arrive in the position of rest illustrated in FIG. 3. Upon shutting, the second stop elements 39 again move away from the associated first stop elements 31. The shutting job is finished by the tailgate 3 being locked by means of the locking unit 6. With the stop elements 31, 39 being spaced apart during the manual shutting process, the drive unit 9 is uncoupled from the power transmission unit 10 when the tailgate 3 is shut, enabling the tailgate 3 to be shut manually without any restrictions. The drive unit 9 is activated neither upon opening nor upon manual shutting of the tailgate 3.

Automatically opening and closing the tailgate 3 will be described below. Automatically opening the tailgate 3 does not differ from manual opening job in a first mode of operation of the operating device 2. In this regard reference is made to the explanation of manual opening process.

Proceeding from FIGS. 2 and 4, the automatic tailgate 3 closing process will be described below. Shutting the tailgate 3 is activated manually first, for example by a key button being pressed, whereupon the control unit activates the drive unit 9. The drive unit 9 is triggered by the control unit in such a way that the drive motor 11 actuates the drive shaft 19 and the gearwheel 22, mounted thereon, in the direction of rotation 28. By rotation of the gearwheel 22, the racks 26, 27 are moved in the associated direction of power transmission 29, 30, the first stop elements 31 entraining the second stop elements 39. The operating elements 34, 35, which are connected with the second stop elements 39, are thus pulled into the casing interior 15 in the respective direction of power transmission 29, 30. The operating power produced by the drive motor 11 is transmitted from the drive unit 9 to the power transmission unit 10 by the stop elements 31, 39 resting on each other, with the operating force acting as tractive force in the respective direction of power transmission 29, 30 on the operating elements 34, 35 that are joined to the second stop elements 39. Thus the tailgate 3 is pivoted by the operating device 2 into the closed position illustrated in FIG. 1. The spring elements 41 are relieved by the tailgate 3 being closed. The closing process is finished by the tailgate 3 being locked by means of the locking unit 6. After the automatic closing process, the operating device 2 is in the position of closing seen in FIG. 5.

For renewed opening of the tailgate 3, the drive unit 9 is triggered in such a way that the gearwheel 22 is driven against the direction of rotation 28 and the racks 26, 27 are moved against the respective direction of power transmission 29, 30. With the second stop elements 39 remaining in their position because the tailgate 3 is closed, the first stop elements 31 move away from them. This process is called reversing. The reversing process is initiated directly after the tailgate 3 has been locked by means of the locking unit 6, enabling the tailgate 3 to be opened again immediately. The reversing job of the operating device 2 is terminated when it arrives in the position of rest seen in FIG. 3.

When the tailgate 3 is closed automatically, the operating device 2 can additionally cooperate with an electromechanical shutting device which acts on the locking unit 6. As a result of a known shutting device of that type, there is no need of supply of additional power in the drive unit 9 for the power increase to be mustered that occurs briefly before the tailgate 3 is closed.

The operating device 2 permits unrestricted manual operation of the tailgate 3 on the one hand and automatic operation of the tailgate 3 on the other, there being no need of any electromechanical coupling for the drive unit 9 and the power transmission unit 10 to be uncoupled. With the stop elements 31, 39 being able to be spaced apart, the drive unit 9 is enabled to be uncoupled from the power transmission unit 10 on the one hand; and with the stop elements 31, 39 being able to rest on each other, transmission of the operating force from the drive unit 9 to the power transmission unit 10 is possible.

In a second mode of operation of the operating device 2, the drive unit 9 can be used for regulating the velocity of the tailgate 3 when opening automatically. Then the operating device 2 does not remain in the position of rest seen in FIG. 3, but it is triggered in such a way that the first stop elements, during the opening process, run ahead of the second stop elements 39 in the respective direction of power transmission 29, 30, thus braking the free motion of the second stop elements 39 and forcing on them a desired velocity. If the drive unit 9 is additionally designed to be self-locking or provided with an additional braking element, then the tailgate 3 can also be stopped in any intermediate positions.

By means of the control unit, the drive unit 9 can additionally be triggered in such a way that protection from someone getting caught when the tailgate 3 is closed is implemented. To this end, the current consumption of the drive motor 11 is monitored and evaluated by the control unit. Position sensors, velocity sensors and/or tactile sensor strips on the tailgate 3 can be used additionally for protection against getting caught being put into practice.

The operating device 2 can be used for operating any pivoted or movable body components 3, for example flaps, doors, spoilers or covers. Furthermore, the to-be-operated body components 3, by single-hinge or multi-hinge arrangement, can be disposed in a linear guide or in a guide of arbitrary course.

The operating device 2 can also be embodied in such a way that the operating elements 34, 35 transmit pressure or that they are actuated parallel in a single direction.

The stop elements 31, 39 can fundamentally be moved along any path, for example in the course of a circle or curve. Furthermore, the stop elements 31, 39 can also be disposed on a spindle or a spindle nut that is movable in relation to the spindle.

What is claimed is:

1. An operating device for operating body components of a vehicle, comprising
a. an electromechanical drive unit (9) for producing an operating power, having
i. a drive motor (11) which is able to be triggered electronically, and
ii. at least one first stop element (31) which is drivable by the drive motor (11);
b. a power transmission unit (10) for transmitting the operating power to at least one body component (3), the power transmission unit (10) having
i. at least one operating element (34, 35) which is connected to the at least one body component (3), and
ii. at least one second stop element (39) which is connected to the at least one operating element (34, 35) and cooperates with the at least one first stop element (31);
c. the drive unit (9) and the power transmission unit (10) being configured such that
i. the at least one first stop element (31) being disposable to bear against the at least one second stop element (39) for transmission of the operating power to the at least one second stop element (39) in a direction of power transmission (29, 30), and
ii. the at least one first stop element (31) being able to be spaced from the at least one second stop element (39) for uncoupling of the drive unit (9) from the power transmission unit (10) in the direction of power transmission (29, 30).

2. An operating device according to claim 1, wherein the power transmission unit (10) comprises at least one spring element (41) which is connected to the at least one second stop element (39).

3. An operating device according to claim 1, wherein the power transmission unit (10) comprises at least one flexible damping element (40) which is disposed between the stop elements (31, 39).

4. An operating device according to claim 1, wherein the at least one operating element (34, 35) is a Bowden cable.

5. An operating device according to claim 1, wherein the drive unit (9) comprises at least one gearwheel (22) which is rotarily drivable by the drive motor (11).

6. An operating device according to claim 5, wherein the drive unit (9) comprises at least one displaceable rack (26, 27) which meshes with the at least one gearwheel (22).

7. An operating device according to claim 6, wherein the at least one first stop element (31) and the at least one rack (26, 27) are one piece.

8. An operating device according to claim 6, wherein the drive unit (9) comprises a casing (12) which guides the at least one rack (26, 27).

9. A method for operating body components of a vehicle, comprising the steps of
a. provision of an operating device (2), having
i. an electromechanical drive unit (9) for producing an operating power, the drive unit (9) having at least one drivable first stop element (31), and
ii. a power transmission unit (10) for transmitting the operating power to at least one body component (3), the power transmission unit (10) having at least one second stop element (39) which is connected to the at least one body component (3); and
b. triggering of the drive unit (9)
i. such that the at least one first stop element (31) for transmission of the operating power to the at least one second stop element (39) in a direction of power transmission (29, 30) is disposed to rest on the at least one second stop element (39), and
ii. such that the at least one first stop element (31) for uncoupling the drive unit (9) from the power transmission unit (10) is disposed at a distance from the at least one second stop element (39) in the direction of power transmission (29, 30).
